(19) United States
(12) Patent Application Publication
(10) Pub. No.: US 2026/0196779 A1
(43) Pub. Date: Jul. 9, 2026

(54) CONNECTOR AND CONNECTOR SET

(71) Applicant: Murata Manufacturing Co., Ltd., Kyoto-fu (JP)

(72) Inventors: Yuuto MORITA, Nagaokakyo-shi (JP); Hideki TSUKAMOTO, Nagaokakyo-shi (JP)

(73) Assignee: Murata Manufacturing Co., Ltd., Kyoto-fu (JP)

(21) Appl. No.: 19/558,110

(22) Filed: Mar. 5, 2026

Related U.S. Application Data
(63) Continuation of application No. PCT/JP2024/031319, filed on Aug. 30, 2024.

(30) Foreign Application Priority Data
Sep. 8, 2023 (JP) 2023-145825

(51) Int. Cl. H01R 13/6585; H01R 12/71; H01R 13/11; H01R 13/46; H01R 13/6582

(52) U.S. Cl. CPC H01R 13/6585; H01R 12/71; H01R 13/113; H01R 13/46; H01R 13/6582

(57) ABSTRACT

A connector includes a first body member having an insulating property, a first signal terminal, and a contact terminal. A first direction is defined as a direction that points from the connector to a second connector when the connector and the second connector are connected to each other. The first body member includes a projection that has an end face facing in the first direction, and a side face connected to the end face. The contact terminal includes a frame portion having the shape of a loop that, as viewed in the first direction, surrounds the periphery of the first signal terminal. The first signal terminal includes a first support extending in the first direction and positioned along the side face. The first support is supported on the side face.

### CROSS-REFERENCE TO RELATED APPLICATIONS

This application claims benefit of priority to International Patent Application No. PCT/JP2024/031319, filed Aug. 30, 2024, and to Japanese Patent Application No. 2023-145825, filed Sep. 8, 2023, the entire contents of each are incorporated herein by reference.

### BACKGROUND

### Technical Field

The present disclosure relates to a connector and a connector set.

### Background Art

A connector set described in Japanese Patent No. 7267186 is known as an example of an disclosure related to a connector in the related art. The connector set in Japanese Patent No. 7267186 includes a first connector, and a second connector configured to mate with the first connector. The first connector includes a first connector body, and a plurality of first connection units loaded into the first connector body. The first connection units each include a first terminal, and a first shield. The second connector includes a second connector body, and a plurality of second connection units loaded into the second connector body. The second connection units each include a second terminal, and a second shield. When the first connector and the second connector are mated, a first contact portion of the first terminal and a second contact portion of the second terminal make contact with each other. At this time, a portion of the first terminal other than the first contact portion includes a first opposed face opposed to the second terminal, as shown, for example, in FIG. 8 of Japanese Patent No. 7267186. A portion of the second terminal other than the second contact portion includes a second opposed face opposed to the first opposed face.

### SUMMARY

In the case of the structure of the connector set described in Japanese Patent No. 7267186, parasitic capacitance is formed between the first opposed face of the first terminal and the second opposed face of the second terminal. The formation of such unexpected parasitic capacitance between the first terminal and the second terminal may result in occurrence of unexpected resonance. Such unexpected resonance is particularly likely to occur when a high-frequency signal is transmitted between the first terminal and the second terminal.

Accordingly, the present disclosure provides a connector and a connector set that are configured to reduce parasitic capacitance formed between signal terminals.

A connector according to an aspect of the present disclosure is a connector to be connected to a second connector. The connector includes a first body member having an insulating property; a first signal terminal; and a contact terminal connected to a ground potential or a power supply potential. A first direction is defined as a direction that points from the connector toward the second connector when the connector and the second connector are connected to each other. The first body member includes a projection. The projection has an end face facing in the first direction and a side face connected to the end face. The contact terminal includes a frame portion having a shape of a loop that, as viewed in the first direction, surrounds a periphery of the first signal terminal. The first signal terminal includes a first support extending in the first direction and shaped to be positioned along the side face. The first support is supported on the side face. When the connector and the second connector are connected to each other, the first support makes contact with a second signal terminal of the second connector. The end face is located in the first direction relative to the first support.

The connector and the connector set according to the present disclosure are configured to reduce parasitic capacitance formed between signal terminals.

### BRIEF DESCRIPTION OF THE DRAWINGS

FIG. 1 is a perspective view of a connector set when a first connector and a second connector are not connected to each other;

FIG. 2 is a perspective view of the first connector;

FIG. 3 is a perspective view of a first body member;

FIG. 4 is a perspective view of a first contact terminal;

FIG. 5 is a perspective view of first signal terminals;

FIG. 6 is a perspective view of the second connector;

FIG. 7 is a perspective view of a second body member;

FIG. 8 is a perspective view of a second contact terminal;

FIG. 9 is a perspective view of second signal terminals;

FIG. 10 is a cross-sectional view of the connector set;

FIG. 11 is a cross-sectional view of a connector set; and

FIG. 12 is a plan view of a first connector.

### DETAILED DESCRIPTION

### First Embodiment

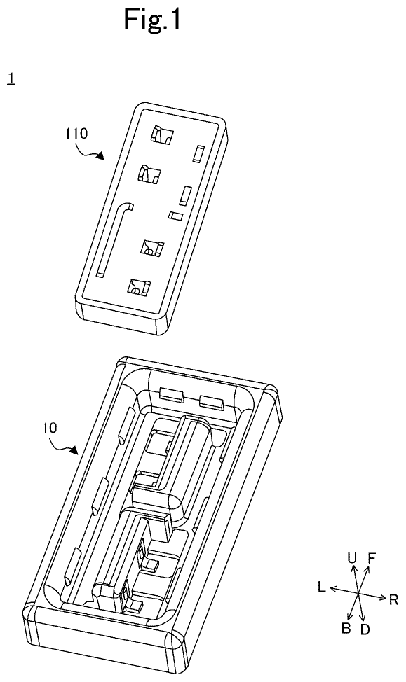

A connector set 1 according to a first embodiment of the present disclosure, which includes a first connector 10, will now be described below with reference to the drawings. FIG. 1 is a perspective view of the connector set 1 when the first connector 10 and a second connector 110 are not connected to each other.

As illustrated in FIG. 1, a direction pointing from the first connector 10 toward the second connector 110 is defined as an upward direction. A direction opposite to the upward direction is defined as a downward direction. The upward direction corresponds to a “first direction” according to the present disclosure. The downward direction corresponds to a “third direction” according to the present disclosure.

The connector set 1 is used to connect two components. The components are, for example, circuit boards. As illustrated in FIG. 1, the connector set 1 includes the first connector 10 and the second connector 110. The first connector 10 is configured to be connected to the second connector 110. The first connector 10 corresponds to a “connector” according to the present disclosure.

### [Structure of First Connector 10]

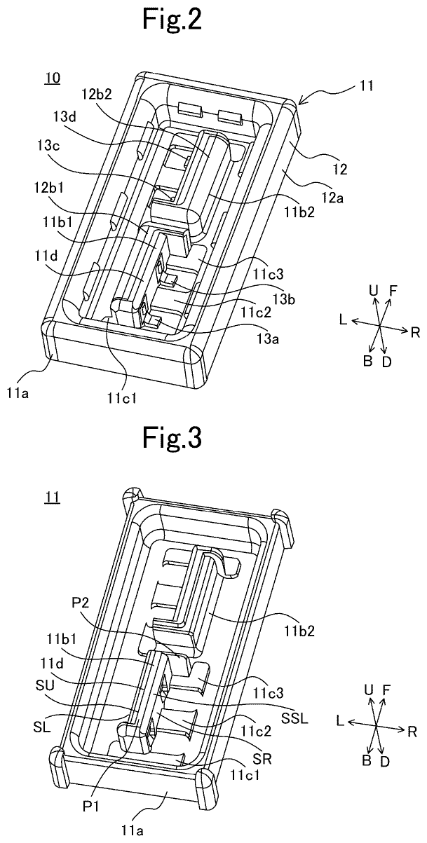

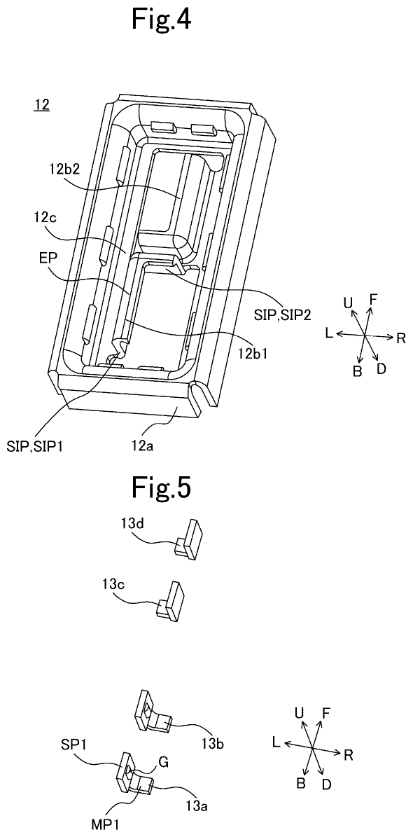

The structure of the first connector 10 will now be described with reference to the drawings. FIG. 2 is a perspective view of the first connector 10. FIG. 3 is a perspective view of a first body member 11. FIG. 4 is a perspective view of a first contact terminal 12. FIG. 5 is a perspective view of first signal terminals 13a to 13d.

As illustrated in FIG. 2, a direction in which first signal terminals 13a and 13b are arranged in this order is defined as a frontward direction. A direction opposite to the frontward direction is defined as a rearward direction. The frontward direction and the rearward direction are orthogonal to the upward direction and the downward direction. A direction orthogonal to the upward direction and the frontward direction and in which a first projection 11b1 of the first body member 11 and the first signal terminal 13a are arranged in this order is defined as a rightward direction. A direction opposite to the rightward direction is defined as a leftward direction. The left-right direction corresponds to a “second direction” according to the present disclosure. The rightward direction corresponds to a “fourth direction” according to the present disclosure. It is to be noted, however, that the upward direction, the downward direction, the frontward direction, the rearward direction, the rightward direction, and the leftward direction are defined herein for the convenience of description. Accordingly, the upward direction, the downward direction, the frontward direction, the rearward direction, the rightward direction, and the leftward direction during actual use of the connector set 1 need not necessarily coincide with these directions as defined herein. Further, in the drawings, the upward direction and the downward direction may be interchanged, the frontward direction and the rearward direction may be interchanged, and the rightward direction and the leftward direction may be interchanged.

As illustrated in FIG. 2, the first connector 10 includes the first body member 11, the first contact terminal 12, and the first signal terminals 13a to 13d. The first contact terminal 12 corresponds to a “contact terminal” according to the present disclosure. There may be at least one “first signal terminal” according to the present disclosure.

As illustrated in FIG. 3, the first body member 11 includes a frame portion 11a, and first projections 11b1 and 11b2. The first body member 11 has an insulating property. According to the present embodiment, the first body member 11 is made of resin. The first body member 11 need not necessarily be made of resin. The first projections 11b1 and 11b2 each correspond to a “projection” according to the present disclosure. There may be at least one “projection” according to the present disclosure.

As illustrated in FIGS. 2 and 3, as viewed in the up-down direction, the frame portion 11a has the shape of a loop surrounding the periphery of the first signal terminals 13a to 13d. The frame portion 11a has a left edge and a right edge that extend in the front-rear direction, and a front edge and a rear edge that extend in the left-right direction.

The first projections 11b1 and 11b2 are arranged in the front-rear direction. According to the present embodiment, the first projection 11b2 has a shape symmetric to that of the first projection 11b1 in the left-right direction and the front-rear direction, and thus will not be described in further detail. The first projection 11b2 need not necessarily have a shape symmetric to that of the first projection 11b1 in the left-right direction and the front-rear direction.

According to the present embodiment, the first projection 11bi has coupling portions 11c to 11c3, and a protruding portion 11d. As viewed in the up-down direction, the coupling portions 11c to 11c3 each cover part of the lower face of the region surrounded by the frame portion 11a. As illustrated in FIG. 2, the coupling portions 11c to 11c3 each couple the protruding portion 11d and the first contact terminal 12 to each other. The first projection 11b1 need not necessarily have the coupling portions 11ci to 11c3.

The protruding portion 11d protrudes in the upward direction from the coupling portions 11c1 to 11c3. As illustrated in FIG. 3, according to the present embodiment, the protruding portion 11d has a first portion P1 extending in the front-rear direction, and a second portion P2 extending in the rightward direction from the front end of the first portion P1. The first portion P1 has an upper end face SU that faces in the upward direction, a lower end face that faces in the downward direction, a front side face that faces in the frontward direction, a rear side face that faces in the rearward direction, a right side face SR that faces in the rightward direction, a left side face SL that faces in the leftward direction, and a sloping face SSL. The sloping face SSL is inclined with respect to the upward direction. According to the present embodiment, the sloping face SSL faces upward to the right. The right side face SR and the left side face SL are each connected to the upper end face SU. According to the present embodiment, the upper end face SU is connected to the right side face SR via the sloping face SSL. The right side face SR of the first portion P1 has two recessed grooves. Each of the two recessed grooves is configured to receive part of the first signal terminal 13a or part of the first signal terminal 13b. The protruding portion 11d need not necessarily have the second portion P2. The first portion P1 need not necessarily have the sloping face SSL. The number of recessed grooves in the right side face SR of the first portion P1 is not limited to two.

According to the present embodiment, the first contact terminal 12 is connected to a ground potential. As illustrated in FIG. 4, the first contact terminal 12 includes a frame portion 12a, first terminal portions 12b1 and 12b2, and a coupling portion 12c. According to the present embodiment, the first contact terminal 12 is produced by subjecting a plate-shaped metal member to a drawing process. The first contact terminal 12 is made of a copper-based material such as copper phosphate. The first contact terminal 12 need not necessarily be connected to a ground potential but may be connected to a power supply potential. The first contact terminal 12 may be produced by subjecting a plate-shaped metal member to a bending process. The first contact terminal 12 need not necessarily be made of a copper-based material such as copper phosphate. The first terminal portions 12b1 and 12b2 each correspond to a “terminal portion” according to the present disclosure. There may be at least one “terminal portion” according to the present disclosure.

As illustrated in FIGS. 2 and 4, as viewed in the up-down direction, the frame portion 12a has the shape of a loop surrounding the periphery of the first signal terminals 13a to 13d. The frame portion 12a has a left edge and a right edge that extend in the front-rear direction, and a front edge and a rear edge that extend in the left-right direction. The frame portion 12a is supported on the frame portion 11a of the first body member 11. According to the present embodiment, the frame portion 12a covers most of the frame portion 11a of the first body member 11. The frame portion 12a need not necessarily cover most of the frame portion 11a of the first body member 11.

As illustrated in FIG. 4, the first terminal portions 12b1 and 12b2 are arranged in the front-rear direction. According to the present embodiment, the first terminal portion 12b2 has a shape symmetric to that of the first terminal portion 12b1 in the left-right direction and the front-rear direction, and thus will not be described in further detail. The first terminal portion 12b2 need not necessarily have a shape symmetric to that of the first terminal portion 12b1 in the left-right direction and the front-rear direction.

As illustrated in FIG. 2, the first terminal portion 12b1 is supported on the protruding portion 11d of the first projection 11b1 of the first body member 11. This will now be explained in more detail. According to the present embodiment, the first terminal portion 12b1 has a side face portion SIP and an end face portion EP as illustrated in FIG. 4. The side face portion SIP and the end face portion EP are connected to each other. The side face portion SIP has a first side face portion SIP1 and a second side face portion SIP2. The first side face portion SIP1 and the second side face portion SIP2 are connected to each other. The side face portion SIP need not necessarily have the second side face portion SIP2.

As illustrated in FIGS. 2 to 4, the first side face portion SIP1 is shaped to be positioned along the left side face SL of the first portion P1. The first side face portion SIP1 is supported on the left side face SL of the first portion P1. According to the present embodiment, the first side face portion SIP1 covers the entire left side face SL of the first portion P1. The second side face portion SIP2 is shaped to be positioned along the front face of the second portion P2. The second side face portion SIP2 is supported on the front face of the second portion P2. According to the present embodiment, the second side face portion SIP2 covers the entire front face of the second portion P2. Due to the above-mentioned configuration, the side face portion SIP is supported on the side face of the first portion P1. The end face portion EP is shaped to be positioned along the upper end face SU of the first portion P1. The end face portion EP is thus supported on the upper end face SU of the first portion P1. According to the present embodiment, the end face portion EP covers the left end portion of the upper end face SU of the first portion P1, and the entire upper face of the second portion P2. The first side face portion SIP1 may cover part of the left side face SL. The second side face portion SIP2 may cover part of the front face of the second portion P2. The end face portion EP need not necessarily cover the entire upper face of the second portion P2, and may cover the entire upper end face SU of the first portion P1.

As viewed in the up-down direction, the coupling portion 12c covers part of the lower face of the region surrounded by the frame portion 12a. The coupling portion 12c couples the frame portion 12a to each of the first terminal portions 12b1 and 12b2. According to the present embodiment, the coupling portion 12c also couples the first terminal portion 12b1 and the first terminal portion 12b2 to each other.

A high-frequency signal is input to or output from each of the first signal terminals 13a to 13d. As illustrated in FIG. 5, the first signal terminals 13a and 13b are arranged in a spaced relationship in the front-rear direction. The first signal terminals 13c and 13d are arranged in a spaced relationship in the front-rear direction. According to the present embodiment, the first signal terminals 13a to 13d are each produced by subjecting a plate-shaped metal member to a bending process. The first signal terminals 13a to 13d are made of a copper-based material such as copper phosphate. According to the present embodiment, the first signal terminal 13b is identical in shape to the first signal terminal 13a, and thus will not be described in further detail. Further, the first signal terminals 13c and 13d each have a shape symmetric to that of the first signal terminal 13a in the left-right direction and the front-rear direction, and thus will not be described in further detail. The first signal terminals 13a to 13d need not necessarily be made of a copper-based material such as copper phosphate. The first signal terminal 13b need not necessarily be identical in shape to the first signal terminal 13a. Each of the first signal terminals 13c and 13d need not necessarily have a shape symmetric to that of the first signal terminal 13a in the left-right direction and the front-rear direction.

The first signal terminal 13a has an L-shape as viewed in the frontward direction. This will now be explained in more detail. The first signal terminal 13a has a first mounting portion MP1 and a first support SP1. The first mounting portion MP1 extends in the left-right direction. When the first connector 10 is mounted to a first circuit board (not illustrated) disposed below the first connector 10, the lower face of the first mounting portion MP1 is electrically connected to an electrode of the first circuit board. The lower face of the first mounting portion MP1 is secured to the electrode of the first circuit board by, for example, solder (not illustrated). The first mounting portion MP1 need not necessarily extend in the left-right direction.

The first support SP1 extends in the upward direction from the left end of the first mounting portion MP1, and is shaped to be positioned along the right side face SR of the first portion P1. That is, the first support SP1 extends in the upward direction, and is shaped to be positioned along the first body member 11. The first support SP1 is embedded into the corresponding recessed groove provided in the right side face SR of the first portion P1. The first support SP1 is thus supported on the right side face SR of the first portion P1. That is, the first support SP1 is supported on the first body member 11. Consequently, the first signal terminal 13a is supported on the first body member 11. The right face of the first support SP1 has a recess G that is recessed in the leftward direction. The first support SP1 may be supported on the first body member 11 by being press-fit into the corresponding recessed groove provided in the right side face SR of the first portion P1. The right face of the first support SP1 need not necessarily have the recess G.

### [Structure of Second Connector 110]

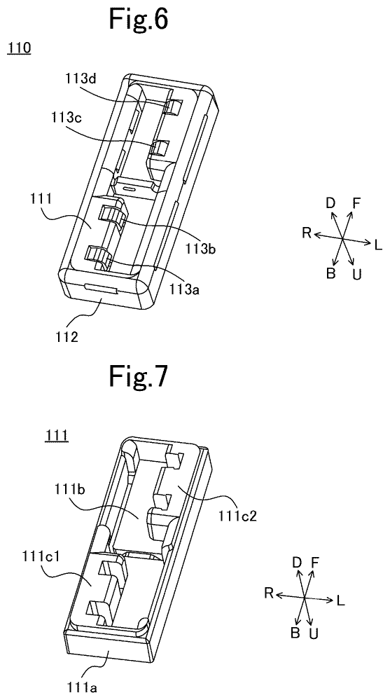

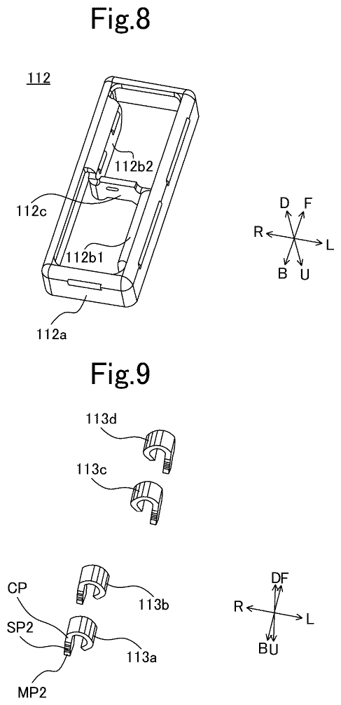

The structure of the second connector 110 will now be described with reference to the drawings. FIG. 6 is a perspective view of the second connector 110. FIG. 7 is a perspective view of a second body member 111. FIG. 8 is a perspective view of a second contact terminal 112. FIG. 9 is a perspective view of second signal terminals 113a to 113d.

As illustrated in FIG. 6, the second connector 110 includes the second body member 111, the second contact terminal 112, and the second signal terminals 113a to 113d.

As illustrated in FIG. 7, the second body member 111 includes a frame portion 111a, a bottom portion 111b, and second projections 111c and 111c2. The second body member 111 has an insulating property. According to the present embodiment, the second body member 111 is made of resin. The second body member 111 need not necessarily be made of resin.

As illustrated in FIGS. 6 and 7, as viewed in the up-down direction, the frame portion 111a has the shape of a loop surrounding the periphery of the second signal terminals 113a to 113d. The frame portion 111a has a left edge and a right edge that extend in the front-rear direction, and a front edge and a rear edge that extend in the left-right direction.

As viewed in the up-down direction, the bottom portion 111b covers part of the lower face of the region surrounded by the frame portion 111a.

The second projection 111c1 is provided at the rear portion of the right edge of the frame portion 111a. According to the present embodiment, the left face of the second projection 111c1 has two recessed grooves. Each of the two recessed grooves is configured to receive part of the second signal terminal 113a or part of the second signal terminal 113b. The number of such recessed grooves is not limited to two.

The second projection 111c2 is provided at the front portion of the left edge of the frame portion 111a. According to the present embodiment, the right face of the second projection 111c2 has two recessed grooves. Each of the two recessed grooves is configured to receive part of the second signal terminal 113c or part of the second signal terminal 113d. The number of such recessed grooves is not limited to two.

According to the present embodiment, the second contact terminal 112 is connected to a ground potential. As illustrated in FIG. 8, the second contact terminal 112 includes a frame portion 112a, second terminal portions 112b1 and 112b2, and a coupling portion 112c. According to the present embodiment, the second contact terminal 112 is produced by subjecting a plate-shaped metal member to a drawing process. The second contact terminal 112 is made of a copper-based material such as copper phosphate. The second contact terminal 112 need not necessarily be connected to a ground potential but may be connected to a power supply potential. The second contact terminal 112 may be produced by subjecting a plate-shaped metal member to a bending process. The second contact terminal 112 need not necessarily be made of a copper-based material such as copper phosphate.

As illustrated in FIGS. 6 and 8, as viewed in the up-down direction, the frame portion 112a has the shape of a loop surrounding the periphery of the second signal terminals 113a to 113d. The frame portion 112a has a left edge and a right edge that extend in the front-rear direction, and a front edge and a rear edge that extend in the left-right direction. The frame portion 112a is supported on the frame portion 111a of the second body member 111. According to the present embodiment, the frame portion 112a covers most of the frame portion 111a of the second body member 111.

As illustrated in FIG. 8, the second terminal portion 112b1 is provided at the rear portion of the left edge of the frame portion 112a. The second terminal portion 112b2 is provided at the front portion of the right edge of the frame portion 112a.

The coupling portion 112c has the shape of a plate extending in the left-right direction. The coupling portion 112c couples the front end of the second terminal portion 112b1, and the rear end of the second terminal portion 112b2 to each other.

A high-frequency signal is input to or output from each of the second signal terminals 113a to 113d. As illustrated in FIG. 9, the second signal terminals 113a and 113b are arranged in a spaced relationship in the front-rear direction. The second signal terminals 113c and 113d are arranged in a spaced relationship in the front-rear direction. According to the present embodiment, the second signal terminal 113b is identical in shape to the second signal terminal 113a, and thus will not be described in further detail. Further, the second signal terminals 113c and 113d each have a shape symmetric to that of the second signal terminal 113a in the left-right direction and the front-rear direction, and thus will not be described in further detail. The second signal terminal 113b need not necessarily be identical in shape to the second signal terminal 113a. Each of the second signal terminals 113c and 113d need not necessarily have a shape symmetric to that of the second signal terminal 113a in the left-right direction and the front-rear direction.

According to the present embodiment, the second signal terminal 113a has a second mounting portion MP2 and a second support SP2. When the second connector 110 is mounted to a second circuit board (not illustrated) disposed above the second connector 110, the upper face of the second mounting portion MP2 is electrically connected to an electrode of the second circuit board. The upper face of the second mounting portion MP2 is secured to the electrode of the second circuit board by, for example, solder (not illustrated). The second mounting portion MP2 need not necessarily extend in the up-down direction. The second circuit board corresponds to a “component” according to the present disclosure.

The second support SP2 extends in the downward direction from the lower end of the second mounting portion MP2. According to the present embodiment, the width of a portion in the front-rear direction of the second support SP2 is greater than the width in the front-rear direction of a portion of the second support SP2 of the second signal terminal 113a other than the above-mentioned portion. The second support SP2 is press-fit into the corresponding recessed groove provided in the left face of the second projection 111c1. The second support SP2 is thus supported on the second body member 111. Consequently, the second signal terminal 113a is supported on the second body member 111. The second support SP2 of the second signal terminal 113a need not necessarily have a width in a portion in the front-rear direction that is greater than the width in the front-rear direction in other portions of the second support SP2. The second support SP2 may be supported on the second body member 111 by being embedded into the corresponding recessed groove provided in the left face of the second projection 111c1. The second support SP2 has a curved portion CP.

### [Structure of Connector Set 1]

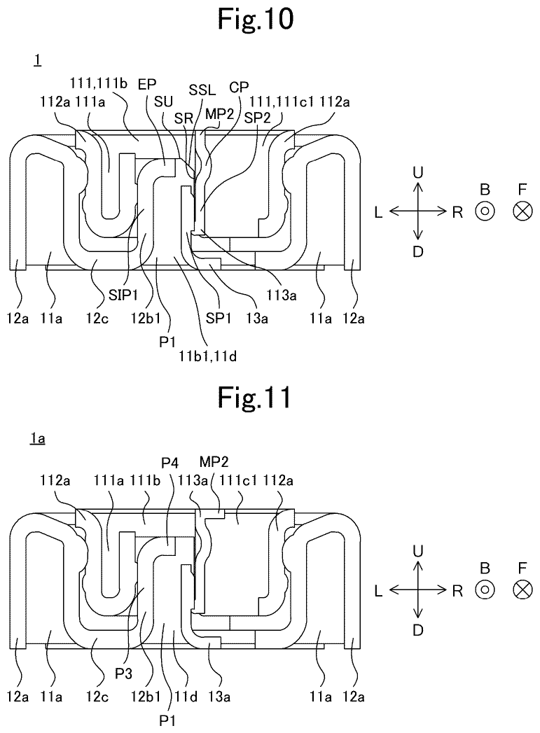

The structure of the connector set 1 will now be described with reference to the drawings. FIG. 10 is a cross-sectional view of the connector set 1. The cross-section of the connector set 1 in FIG. 10 is a plane passing through the first signal terminal 13a and orthogonal to the front-rear direction.

As illustrated in FIG. 1, with the first connector 10 viewed in the up-down direction, the second body member 111 of the second connector 110 is inserted into the region surrounded by the frame portion 11a of the first connector 10. The first connector 10 is connected to the second connector 110 in the up-down direction. According to the present embodiment, when the first connector 10 and the second connector 110 are connected to each other, the direction pointing from the first connector 10 toward the second connector 110 is the upward direction. At this time, as viewed in the up-down direction, the frame portion 11a of the first connector 10, and the frame portion 111a of the second connector 110 do not overlap each other. Further, as viewed in the up-down direction, the respective protruding portions 11d of the first and second projections 11bi and 11b2 of the first connector 10, and the second projections 111c1 and 111c2 of the second connector 110 do not overlap each other.

As illustrated in FIG. 10, the first contact terminal 12 and the first signal terminal 13a are supported on the protruding portion 11d of the first projection 11b1. The first projection 11b1 is sandwiched between the first signal terminal 13a and the first terminal portion 12b1 of the first contact terminal 12 in the left-right direction. The first side face portion SIP1 of the first contact terminal 12 covers the entire left side face SL of the first portion P1 of the protruding portion 11d of the first projection 11b1. The end face portion EP of the first contact terminal 12 covers the left end portion of the upper end face SU of the first portion P1 of the protruding portion 11d of the first projection 11b1. The first support SP1 of the first signal terminal 13a covers part of the right side face SR of the first portion P1 of the protruding portion 11d of the first projection 11b1. The upper end face SU of the first portion P1 of the protruding portion 11d of the first projection 11b1 is located above the first support SP1 of the first signal terminal 13a. Accordingly, the first signal terminal 13a is not exposed from the upper end face SU of the first portion P1 of the protruding portion 11d of the first projection 11b1. The upper end of the first contact terminal 12 is located above the first signal terminal 13a.

When the first connector 10 and the second connector 110 are connected to each other, the first signal terminals 13a to 13d of the first connector 10 are respectively connected to the second signal terminals 113a to 113d of the second connector 110. At this time, the respective second supports SP2 of the second signal terminals 113a to 113d make contact at their distal ends with the recesses G provided in the respective right faces of the first supports SP1 of the first signal terminals 13a to 13d. That is, when the first connector 10 and the second connector 110 are connected to each other, the respective second supports SP2 of the second signal terminals 113a to 113d make contact with the respective first supports SP1 of the first signal terminals 13a to 13d. Further, when the first connector 10 and the second connector 110 are connected to each other, the respective first supports SP1 of the first signal terminals 13a to 13d do not overlap the second signal terminals 113a to 113d as viewed in the up-down direction. The first signal terminals 13a to 13d are thus electrically connected to the second signal terminals 113a to 113d, respectively. Further, the respective distal ends of the second supports SP2 of the second signal terminals 113a to 113d become caught in the recesses G provided in the respective right faces of the first supports SP1 of the first signal terminals 13a to 13d. This reduces the likelihood of disconnection between the first signal terminals 13a to 13d and the corresponding second signal terminals 113a to 113d. The first contact terminal 12 of the first connector 10 is connected to the second contact terminal 112 of the second connector 110.

As viewed in the upward direction, the sloping face SSL of the first portion P1 overlaps the first support SP1 of each of the first signal terminals 13a to 13d. The first support SP1 of the first signal terminal 13a, the second support SP2 of the second signal terminal 113a, and the second body member 111 are arranged in this order in the rightward direction. The curved portion CP of the second signal terminal 113a is curved to protrude in the rightward direction. The curved portion CP is supported on the second body member 111. At a location near the second mounting portion MP2, the second support SP2 of the second signal terminal 113a is supported on the second body member 111 by being held on opposite sides by the second body member 111. As viewed in the upward direction, the second mounting portion MP2 of the second signal terminal 113a does not overlap the first support SP1 of the first signal terminal 13a.

### Advantageous Effects

The first connector 10 is configured to reduce parasitic capacitance formed between the first signal terminal 13a and the second signal terminal 113a. This will now be explained in more detail. A high-frequency signal is input to or output from each of the first signal terminals 13a to 13d. The first connector 10 includes the first contact terminal 12, which includes the frame portion 12a in the shape of a loop that surrounds the periphery of the first signal terminals 13a to 13d as viewed in the up-down direction. The frame portion 12a provides shielding against the conduction of noise emitted by the first signal terminals 13a to 13d to the outside of the region surrounded by the frame portion 12a. Further, the frame portion 12a provides shielding against the conduction of noise to the first signal terminals 13a to 13d from the outside of the region surrounded by the frame portion 12a. Under the electromagnetically shielded environment mentioned above, parasitic capacitance formed between the first signal terminal 13a and the second signal terminal 113a may result in occurrence of unexpected resonance, which is a major cause of noise disturbance. Accordingly, the first connector 10 is configured such that the first support SP1 of the first signal terminal 13a extends in the upward direction, and is shaped to be positioned along the right side face SR of the first portion P1 of the first body member 11. The first support SP1 is embedded into the corresponding recessed groove provided in the right side face SR of the first portion P1. The first support SP1 is thus supported on the right side face SR of the first portion P1. The first support SP1 is located below the upper end face SU of the first portion P1. This configuration makes it possible to reduce the area where the first signal terminal 13a and the second signal terminal 113a face each other, as compared with a case in which the upper end of the first support SP1 is located above the upper end face SU of the first portion P1. This in turn makes it possible to reduce parasitic capacitance formed between the first signal terminal 13a and the second signal terminal 113a. As a result, the above-mentioned configuration of the first connector 10 makes it possible to reduce parasitic capacitance formed between signal terminals. This in turn makes it possible to reduce the occurrence of unexpected resonance, and reduce the occurrence of noise disturbance.

The first connector 10 is also configured to reduce the likelihood of damage to the first connector 10. This will now be explained in more detail. When the first connector 10 and the second connector 110 are connected to each other, the second signal terminal 113a is located above the first support SP1 of the first signal terminal 13a. Consequently, in connecting the first connector 10 and the second connector 110 to each other, the second signal terminal 113a may come into contact with the upper end face SU of the first portion P1, and thus cause damage to the first body member 11. In this regard, the first connector 10 is configured such that the upper end face SU is connected to the right side face SR via the sloping face SSL. As viewed in the upward direction, the sloping face SSL overlaps the first support SP1 of the first signal terminal 13a. This configuration makes it possible to prevent the second signal terminal 113a from coming into contact with the upper end face SU of the first portion P1 when the first connector 10 and the second connector 110 are connected to each other. This in turn helps to reduce the likelihood of damage to the first connector 10.

The connector set 1 is also configured to firmly connect the first signal terminal 13a and the second signal terminal 113a to each other. This will now be explained in more detail. When the first connector 10 and the second connector 110 are connected to each other, the first signal terminal 13a exerts a rightward force on the second signal terminal 113a. The rightward force tends to cause the second signal terminal 113a to move away from the first signal terminal 13a. In this regard, the curved portion CP of the second signal terminal 113a, which is curved to protrude in the rightward direction, is supported on the second body member 111. This allows for improved elasticity of the curved portion CP. Further, when the second signal terminal 113a receives a rightward force from the first signal terminal 13a, the curved portion CP exerts a reaction in the leftward direction. This allows the second signal terminal 113a to receive a large leftward force from the second body member 111. The leftward force causes the second signal terminal 113a to make firm contact with the first signal terminal 13a. Therefore, as compared with a case in which the second signal terminal 113a has no curved portion CP, a large leftward force is exerted on the second signal terminal 113a, and the first signal terminal 13a and the second signal terminal 113a are thus firmly connected to each other. As a result, the above-mentioned configuration of the connector set 1 makes it possible to firmly connect the first signal terminal 13a and the second signal terminal 113a to each other.

The connector set 1 is also configured to enable miniaturization of the connector set. This will now be explained in more detail. At a location near the second mounting portion MP2, the second support SP2 of the second signal terminal 113a is supported on the second body member 111 by being held on opposite sides by the second body member 111. Therefore, the second connector 110 can be reduced in length in the left-right direction as compared with a case in which a gap exists in the left-right direction between the second support SP2 and the second body member 111. Consequently, the first connector 10 can be reduced in length in the left-right direction. This allows the connector set 1 to be reduced in length in the left-right direction. As a result, the above-mentioned configuration of the connector set 1 enables miniaturization of the connector set.

The connector set 1 is configured such that, as viewed in the upward direction, the second mounting portion MP2 of the second signal terminal 113a does not overlap the first support SP1 of the first signal terminal 13a. If it is now supposed that the second mounting portion MP2 overlaps the first support SP1 as viewed in the upward direction, then the second mounting portion MP2 and the first support SP1 face each other. This increases the area where the first signal terminal 13a and the second signal terminal 113a face each other. In contrast, according to the present embodiment, the second mounting portion MP2 of the second signal terminal 113a does not overlap the first support SP1 of the first signal terminal 13a as viewed in the upward direction. This makes it possible to reduce the area where the first signal terminal 13a and the second signal terminal 113a face each other. This makes it possible to further reduce parasitic capacitance formed between the first signal terminal 13a and the second signal terminal 113a. As a result, the above-mentioned configuration of the first connector 10 makes it possible to reduce parasitic capacitance formed between signal terminals.

### First Modification

A connector set 1a according to a first modification of the present disclosure will now be described with reference to the drawings. FIG. 11 is a cross-sectional view of the connector set 1a. As for the connector set 1a according to the first modification, only its features different from those of the connector set 1 according to the first embodiment will be described, and the remaining features will not be described in further detail.

The connector set 1a according to the first modification differs from the connector set 1 according to the first embodiment in the shape of the second signal terminal 113a.

According to the present modification, the second mounting portion MP2 of the second signal terminal 113a extends in the left-right direction. According to the present modification as well, the second mounting portion MP2 of the second signal terminal 113a does not overlap the first support SP1 of the first signal terminal 13a as viewed in the upward direction.

The connector set 1a configured as described above provides the same advantageous effects as those of the connector set 1.

### Second Modification

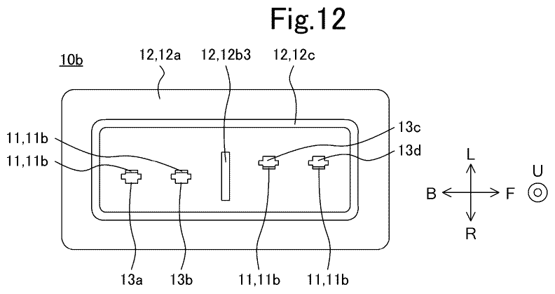

A first connector 10b according to a second modification of the present disclosure will now be described with reference to the drawings. FIG. 12 is a plan view of the first connector 10b. As for the first connector 10b according to the second modification, only its features different from those of the first connector 10 according to the first embodiment will be described, and the remaining features will not be described in further detail.

According to the present modification, each single first projection 11b supports one of the first signal terminals 13a to 13d. A first terminal portion 12b3 of the first contact terminal 12 is located between the first signal terminal 13b and the first signal terminal 13c. As viewed in the left-right direction, the first terminal portion 12b3 of the first contact terminal 12 overlaps the first signal terminals 13a to 13d. As viewed in the up-down direction, the first connector 10b has a shape that is symmetric about a point.

The first connector 10b configured as described above provides the same advantageous effects as those of the first connector 10.

The connector according to the present disclosure is not limited to the first connectors 10 and 10b but may be subject to changes within the scope of the present disclosure. The structural features of the first connectors 10 and 10b may be combined in any desired manner.

### Other Embodiments

The connector set according to the present disclosure is not limited to the connector sets 1 and 1a but may be subject to changes within the scope of the present disclosure. The structural features of the connector sets 1 and 1a may be combined in any desired manner.

The present disclosure has features described below.
(1) A connector to be connected to a second connector, the connector comprising a first body member having an insulating property; a first signal terminal; and a contact terminal connected to a ground potential or a power supply potential. A first direction is defined as a direction that points from the connector toward the second connector when the connector and the second connector are connected to each other. The first body member includes a projection, the projection having an end face facing in the first direction and a side face connected to the end face. The contact terminal includes a frame portion having a shape of a loop that, as viewed in the first direction, surrounds a periphery of the first signal terminal. The first signal terminal includes a first support extending in the first direction and shaped to be positioned along the side face, the first support being supported on the side face. Also, when the connector and the second connector are connected to each other, the first support makes contact with a second signal terminal of the second connector, and the end face is located in the first direction relative to the first support.
(2) The connector according to (1), wherein the projection has a sloping face inclined with respect to the first direction. Also, as viewed in the first direction, the sloping face overlaps the first support, and the end face is connected to the side face via the sloping face.
(3) The connector according to (1) or (2), wherein the contact terminal includes a terminal portion, and in a second direction orthogonal to the first direction, the projection is sandwiched between the first signal terminal and the terminal portion.
(4) The connector according to (3), wherein the terminal portion has a side face portion supported on the side face, and an end face portion connected to the side face portion and supported on the end face.
(5) The connector according to (3) or (4), wherein the contact terminal includes a coupling portion that couples the frame portion and the terminal portion to each other.
(6) The connector according to any one of (1) to (5), wherein a high-frequency signal is input to or output from the first signal terminal.
(7) A connector set comprising the connector according to any one of (1) to (6); and the second connector. The second connector includes a second body member having an insulating property, and the second signal terminal. Also, the second signal terminal includes a second support extending in a third direction opposite to the first direction, the second support making contact with the first support when the connector and the second connector are connected to each other. In addition, when the connector and the second connector are connected to each other, the first support, the second support, and the second body member are arranged in this order in a fourth direction orthogonal to the first direction. The second support has a curved portion, the curved portion being curved to protrude in the fourth direction, and the curved portion is supported on the second body member.
(8) A connector set comprising the connector according to any one of (1) to (6); and the second connector. The second connector includes a second body member having an insulating property, and the second signal terminal supported on the second body member. The second signal terminal includes a second mounting portion to be electrically connected to an electrode of a component, the component being different from the connector and the second connector, and a second support extending from the second mounting portion in a third direction opposite to the first direction, the second support making contact with the first support when the connector and the second connector are connected to each other. Also, at a location near the second mounting portion, the second support is supported on the second body member by being held on opposite sides by the second body member.
(9) A connector set comprising the connector according to any one of (1) to (6); and the second connector. The second connector includes a second body member having an insulating property, and the second signal terminal supported on the second body member. The second signal terminal includes a second mounting portion to be electrically connected to an electrode of a component, the component being different from the connector and the second connector, and a second support extending from the second mounting portion in a third direction opposite to the first direction, the second support making contact with the first support when the connector and the second connector are connected to each other. Also, as viewed in the first direction, the second mounting portion does not overlap the first support.

What is claimed is:

1. A connector configured to connect to a second connector, the connector comprising:
a first body member having an insulating property;
a first signal terminal; and
a contact terminal connected to a ground potential or a power supply potential,
wherein
a first direction is defined as a direction that points from the connector toward the second connector when the connector and the second connector are connected to each other,
the first body member includes a projection, the projection having an end face facing in the first direction and a side face connected to the end face,
the contact terminal includes a frame portion having a shape of a loop that, as viewed in the first direction, surrounds a periphery of the first signal terminal,
the first signal terminal includes a first support extending in the first direction and positioned along the side face, the first support being supported on the side face,
when the connector and the second connector are connected to each other, the first support makes contact with a second signal terminal of the second connector, and
the end face is located in the first direction relative to the first support.

2. The connector according to claim 1, wherein
the projection has a sloping face inclined with respect to the first direction,
as viewed in the first direction, the sloping face overlaps the first support, and
the end face is connected to the side face via the sloping face.

3. The connector according to claim 1, wherein
the contact terminal includes a terminal portion, and
in a second direction orthogonal to the first direction, the projection is sandwiched between the first signal terminal and the terminal portion.

4. The connector according to claim 3, wherein
the terminal portion has
a side face portion supported on the side face, and
an end face portion connected to the side face portion and supported on the end face.

5. The connector according to claim 3, wherein
the contact terminal includes a coupling portion that couples the frame portion and the terminal portion to each other.

6. The connector according to claim 1, wherein
the first signal terminal is configured to input or output a high-frequency signal.

7. A connector set comprising:
the connector according to claim 1; and
the second connector,
wherein
the second connector includes
a second body member having an insulating property, and
the second signal terminal,
the second signal terminal includes a second support extending in a third direction opposite to the first direction, the second support making contact with the first support when the connector and the second connector are connected to each other,
when the connector and the second connector are connected to each other, the first support, the second support, and the second body member are arranged in this order in a fourth direction orthogonal to the first direction,
the second support has a curved portion, the curved portion being curved to protrude in the fourth direction, and
the curved portion is supported on the second body member.

8. A connector set comprising:
the connector according to claim 1; and
the second connector,
wherein
the second connector includes
a second body member having an insulating property, and
the second signal terminal supported on the second body member,
the second signal terminal includes
a second mounting portion configured to electrically connect to an electrode of a component, the component being different from the connector and the second connector, and
a second support extending from the second mounting portion in a third direction opposite to the first direction, the second support making contact with the first support when the connector and the second connector are connected to each other, and
at a location near the second mounting portion, the second support is supported on the second body member by being held on opposite sides by the second body member.

9. A connector set comprising:
the connector according to claim 1; and
the second connector,
wherein
the second connector includes
a second body member having an insulating property, and
the second signal terminal supported on the second body member,
the second signal terminal includes
a second mounting portion configured to electrically connect to an electrode of a component, the component being different from the connector and the second connector, and
a second support extending from the second mounting portion in a third direction opposite to the first direction, the second support making contact with the first support when the connector and the second connector are connected to each other, and
as viewed in the first direction, the second mounting portion does not overlap the first support.

10. The connector according to claim 2, wherein
the contact terminal includes a terminal portion, and
in a second direction orthogonal to the first direction, the projection is sandwiched between the first signal terminal and the terminal portion.

11. The connector according to claim 4, wherein
the contact terminal includes a coupling portion that couples the frame portion and the terminal portion to each other.

12. The connector according to claim 2, wherein
the first signal terminal is configured to input or output a high-frequency signal.

13. The connector according to claim 3, wherein
the first signal terminal is configured to input or output a high-frequency signal.

14. A connector set comprising:
the connector according to claim 2; and
the second connector,
wherein
the second connector includes
a second body member having an insulating property, and
the second signal terminal,
the second signal terminal includes a second support extending in a third direction opposite to the first direction, the second support making contact with the first support when the connector and the second connector are connected to each other,
when the connector and the second connector are connected to each other, the first support, the second support, and the second body member are arranged in this order in a fourth direction orthogonal to the first direction,
the second support has a curved portion, the curved portion being curved to protrude in the fourth direction, and
the curved portion is supported on the second body member.

15. A connector set comprising:
the connector according to claim 3; and
the second connector,
wherein
the second connector includes
a second body member having an insulating property, and
the second signal terminal,
the second signal terminal includes a second support extending in a third direction opposite to the first direction, the second support making contact with the first support when the connector and the second connector are connected to each other,
when the connector and the second connector are connected to each other, the first support, the second support, and the second body member are arranged in this order in a fourth direction orthogonal to the first direction,
the second support has a curved portion, the curved portion being curved to protrude in the fourth direction, and
the curved portion is supported on the second body member.

16. A connector set comprising:
the connector according to claim 2; and
the second connector,
wherein
the second connector includes
a second body member having an insulating property, and
the second signal terminal supported on the second body member,
the second signal terminal includes
a second mounting portion configured to electrically connect to an electrode of a component, the component being different from the connector and the second connector, and
a second support extending from the second mounting portion in a third direction opposite to the first direction, the second support making contact with the first support when the connector and the second connector are connected to each other, and
at a location near the second mounting portion, the second support is supported on the second body member by being held on opposite sides by the second body member.

17. A connector set comprising:
the connector according to claim 3; and
the second connector,
wherein
the second connector includes
a second body member having an insulating property, and
the second signal terminal supported on the second body member,
the second signal terminal includes
a second mounting portion configured to electrically connect to an electrode of a component, the component being different from the connector and the second connector, and
a second support extending from the second mounting portion in a third direction opposite to the first direction, the second support making contact with the first support when the connector and the second connector are connected to each other, and
at a location near the second mounting portion, the second support is supported on the second body member by being held on opposite sides by the second body member.

18. A connector set comprising:
the connector according to claim 2; and
the second connector,
wherein
the second connector includes
a second body member having an insulating property, and
the second signal terminal supported on the second body member,
the second signal terminal includes
a second mounting portion configured to electrically connect to an electrode of a component, the component being different from the connector and the second connector, and
a second support extending from the second mounting portion in a third direction opposite to the first direction, the second support making contact with the first support when the connector and the second connector are connected to each other, and
as viewed in the first direction, the second mounting portion does not overlap the first support.

19. A connector set comprising:
the connector according to claim 3; and
the second connector,
wherein
the second connector includes
a second body member having an insulating property, and
the second signal terminal supported on the second body member,
the second signal terminal includes
a second mounting portion configured to electrically connect to an electrode of a component, the component being different from the connector and the second connector, and
a second support extending from the second mounting portion in a third direction opposite to the first direction, the second support making contact with the first support when the connector and the second connector are connected to each other, and
as viewed in the first direction, the second mounting portion does not overlap the first support.

20. A connector set comprising:
a first connector; and
a second connector configured to connect to the first connector,
wherein
the first connector includes
a body member having an insulating property, and
a first signal terminal,
the second connector includes a second signal terminal,
a first direction is defined as a direction that points from the first connector toward the second connector when the first connector and the second connector are connected to each other,
the first signal terminal includes a first support extending in the first direction and positioned along the body member, the first support being supported on the body member, and
when the first connector and the second connector are connected to each other, the first support makes contact with the second signal terminal and, as viewed in the first direction, does not overlap the second signal terminal.
